(19) United States
(12) Patent Application Publication
(10) Pub. No.: US 2005/0117998 A1
(43) Pub. Date: Jun. 2, 2005

(54) Fastener assembly with locking washer

(76) Inventor: Farrokh Patell, Lincolnwood, IL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/999,878

(22) Filed: Nov. 30, 2004

Related U.S. Application Data
(60) Provisional application No. 60/526,040, filed on Dec. 1, 2003.

(51) Int. Cl. F16B 13/04

(52) U.S. Cl. 411/398

(57) ABSTRACT

A fastener assembly for securing a first structure to a second structure. The fastener assembly generally includes a bolt, a nut, and a locking washer. The locking washer has a plurality of side walls and corner regions. The locking washer has an eccentric aperture, meaning an aperture that is off-center or not aligned with the center of the locking washer. The locking washer is rotatable between an initial position wherein a first side wall does not engage the second structure, an intermediate position wherein a first corner slidably engages the second structure, and a locked position wherein a second side wall engages the second structure. The side walls have numerous teeth configured to engage the second structure in the locked position. In the locked position, the locking washer exerts both a clamping force and a gripping force to fixedly secure the first structure and the second structure.

### CROSS-REFERENCE TO RELATED APPLICATIONS

This application claims priority from U.S. Provisional Application No. 60/526,040, filed Dec. 1, 2003.

### TECHNICAL FIELD

The present invention relates to a fastener assembly. More specifically, the present invention provides a fastener assembly with a locking washer to secure a first structure to a second structure.

### BACKGROUND OF THE INVENTION

There are numerous fastener assemblies currently available for both commercial applications and residential use. Conventional fastener assemblies generally include a bolt, a washer, and a nut to fasten a first object to a second object. Typically, the first object is positioned adjacent to the second object such that the first object is in direct contact with the second object. The washer and nut receive an extent of the bolt to secure the first and second objects. In use, the washer is positioned between the nut and one of the objects. Conventional washers are usually fabricated from metal or plastics and have ring-shaped configuration with a central opening to receive a portion of the bolt. Conventional nuts are also formed from metal or plastics and have a hexagonal configuration with a central opening to receive the bolt.

Generally, the first object has a portion that passes through a slot in the second object. The fastener assembly extends through an opening in the second object. A clearance or gap is defined by the distance between a surface of the second object and the fastener assembly. Conventional fastener assemblies have no structures that reduce or eliminate the clearance. Specifically, neither the washer nor the nut can reduce or eliminate the clearance. Thus, conventional fastener assemblies cannot properly secure the first object and the second object.

Therefore, there is a need for a fastener assembly with at least one structure that eliminates the clearance to secure the first object to the second object.

The present invention is provided to solve these and other deficiencies.

### SUMMARY OF THE INVENTION

The present invention relates to a fastener assembly that includes a nut, a locking washer, and a bolt. The fastener assembly is configured to rigidly secure a first structure to a second or support structure. A tab extends from the first structure through a slot in the support structure. The tab has an opening that receives the bolt and to which the locking washer and the nut are attached. The locking washer is adapted to engage an inner surface of the second structure to secure the first structure thereto. The locking washer has a plurality of side walls and a plurality of rounded corners. Preferably, each side wall has numerous teeth, which can be linear or angled. The locking washer has an internal aperture; however, the aperture is not aligned with the center of the locking washer. Thus, the aperture is positioned off-center within the locking washer. Because the aperture is positioned off-center, the distance from the edge or periphery of the aperture to each of the side walls and corners is distinct. Similarly, the distance from the center of the aperture to each of the side walls and corners is distinct.

The first structure is positioned adjacent to the second structure whereby the tab is inserted through the slot. Once the first structure is properly positioned with respect to the second structure, the bolt is inserted through the opening in the tab. The locking washer is then placed in a first position wherein the bolt is received by the locking washer. In the first position, a first clearance exists and is defined by the distance between the first side wall of the locking washer and the inner surface of the second structure. Due to the clearance, there is no engagement between the locking washer and the second structure. Because the locking washer has an eccentric aperture and the lengths to the side walls are distinct, the locking washer can be selectively rotated to eliminate the clearance and bring a side wall into engagement with the inner surface. Depending upon the amount of rotation necessary, a corner region of the locking washer may engage the inner surface of the support structure. The corner region is deformable such that the locking washer can be further rotated to bring a side wall into engagement with the inner surface. When the side wall engages the inner surface of the support structure, the locking washer and the fastener assembly are in a locking position. In the locking position, the locking washer exerts a clamping force and a gripping force on the inner surface.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a fastener assembly of the invention, showing a first structure secured by the fastener assembly to a second structure;

FIG. 2 is a perspective view of a locking washer of the fastener assembly of FIG. 1;

FIG. 3 is a top plan view of the locking washer of the fastener assembly of FIG. 1;

FIG. 4 is a cross-section of the locking washer taken along line 4-4 of FIG. 3;

FIG. 5 is a cross-section of the locking washer taken along line 5-5 of FIG. 3;

FIG. 6 is a cross-section of the locking washer taken along line 6-6 of FIG. 3;

FIG. 7 is an exploded view of the fastener assembly, the first structure and the second structure of FIG. 1;

FIG. 8 is a partial cross-section view of the fastener assembly of FIG. 1, showing the locking washer in a first position;

FIG. 9 is a partial cross-section view of the fastener assembly of FIG. 1, showing the locking washer in a second position;

FIG. 10 is a partial cross-section view of the fastener assembly of FIG. 1, showing the locking washer in a third position;

FIG. 11 is a partial cross-section view of the fastener assembly of FIG. 1, showing the locking washer in a fourth position;

FIG. 12 is a partial cross-section view of the fastener assembly of FIG. 1, showing the locking washer in a fifth position; and,

FIG. 13 is a partial cross-section view of the fastener assembly of FIG. 1, showing an alternate embodiment of the locking washer in the fifth position.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

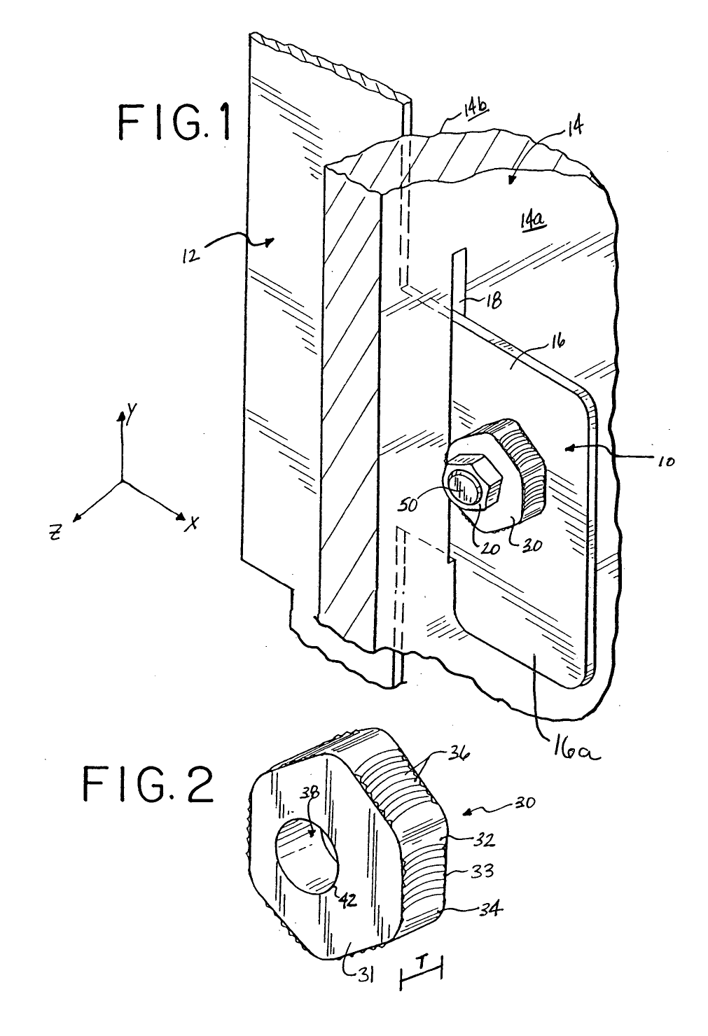

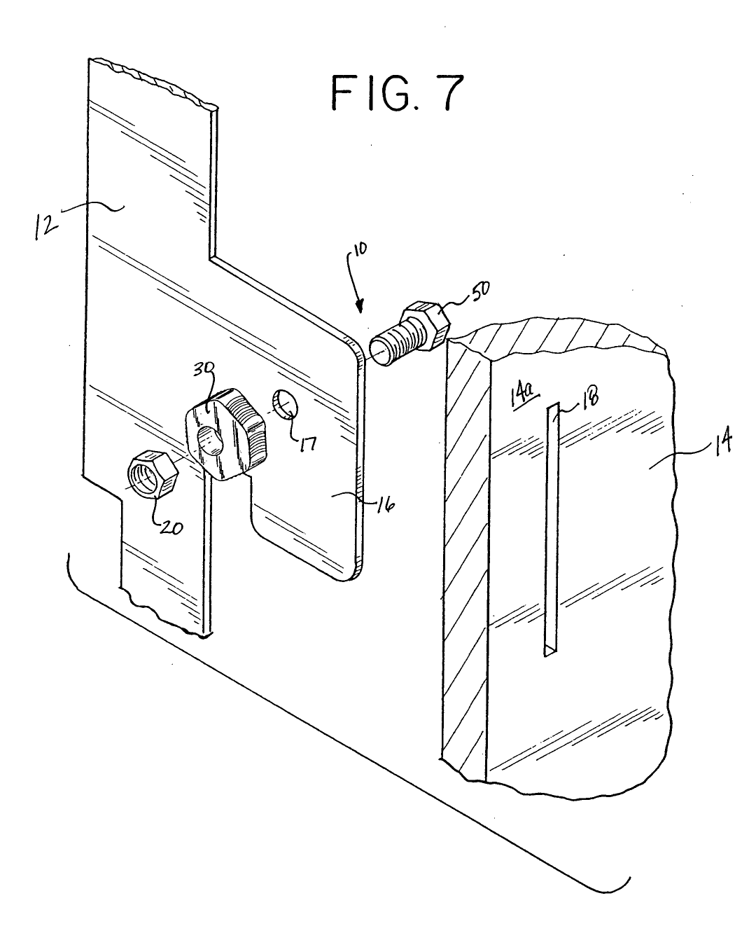

A fastener assembly 10 is shown in FIGS. 1 and 7. The fastener assembly 10 includes a nut 20, a locking washer 30, and a bolt 50. In general terms, the fastener assembly 10 is configured to rigidly secure a first or display structure 12 to a second or support structure 14. As shown in FIG. 1, the first structure 12 and the second structure 14 are generally vertical structures and the fastener assembly 10 secures the first structure 12 to the second structure 14. A tab 16 extends from the first structure 12 through a slot 18 in the support structure 14. Once the tab 16 is inserted thorough the slot 18, the bolt 50 is inserted through an opening 17 of the tab 16. Although the tab 16 is shown with a lower lobe 16a that interacts with the second structure 14, the lobe 16a can be omitted from the tab 16. As explained in greater detail below, the nut 20 and the locking washer 30 are brought into engagement with the portion of the bolt 50 that extends beyond the tab 16. Although only a single fastener assembly 10 is shown, it is understood that multiple assemblies 10 could be used to secure the first and second structures 12, 14. The nut 20 can be a lock nut.

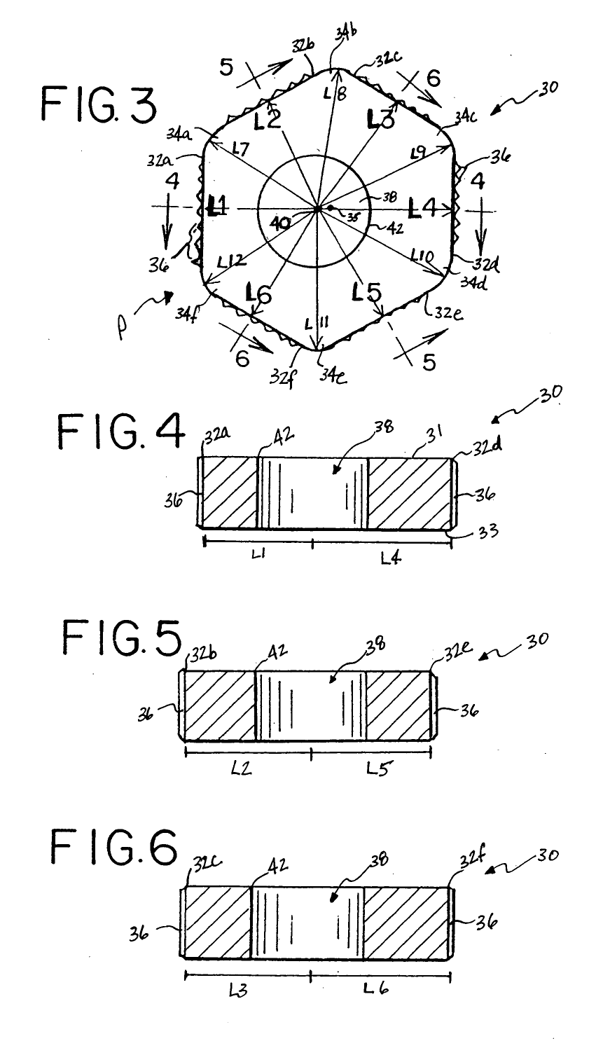

The locking washer 30 is adapted to engage an inner surface 14a of the second structure 14 to secure the first structure 12 thereto. Referring to FIGS. 2 and 3, the locking washer 30 has a plurality of side walls 32 and a plurality of corners 34. Preferably, the corners 34 have a rounded configuration. The locking washer 30 has a first end wall 31 and a second end wall 33 wherein the end walls 31, 33 are substantially parallel. Alternatively, at least one of the end walls 31, 33 is angled or sloped. The locking washer 30 has a center or centrum 35. Preferably, each side wall 32 has numerous teeth 36. Although shown as being curvilinear, the teeth 36 can be linear or angled. Also, the teeth 36 can span the entire length of the side wall 32, or be intermittently spaced along the side wall 32. The locking washer 30 has a thickness T that varies with the design parameters of the washer 30. The locking washer 30 has a perimeter P, which is defined by the side walls 32.

The locking washer 30 has an internal aperture 38; however, the aperture 38 is not aligned with the center 35 of the locking washer 30. In other words, the aperture 38 is positioned off-center within the locking washer 30. Described in a different manner, a center 40 of the aperture 38 is eccentric with the center 35 of the locking washer 30. Although not shown, the aperture 38 can be threaded. Because the aperture 38 is positioned off-center, the distance from the edge or periphery 42 of the aperture 38 to each of the side walls 32 and corners 34 is distinct. Similarly, the distance from the center 40 of the aperture 38 to each of the side walls 32 and corners 34 is distinct. Referring to FIGS. 3-6, the distance from the aperture center 40 to the first side wall 32a is L1; the distance from the aperture center 40 to the second side wall 32b is L2; the distance from aperture center 40 to the third side wall 32c is L3; the distance from aperture center 40 to the fourth side wall 32d is L4; the distance from aperture center 40 to the fifth side wall 32e is L5; and, the distance from aperture center 40 to the sixth side wall 32f is L6. Due to the fact that the aperture 38 is off-center, these distances (L1-L6) are dissimilar. As shown in FIGS. 4-6, there is an unequal amount of material in the regions about the aperture 38.

Referring to FIG. 3, the distance from the aperture center 40 to the first corner 34a is L7; the distance from the aperture center 40 to the second corner 34b is L8; the distance from the aperture center 40 to the third corner 34c is L9; the distance from the aperture center 40 to the fourth corner 34d is L10; the distance from the aperture center 40 to the fifth corner 34e is L11; and, the distance from the aperture center 40 to the sixth corner 34f is L12. Since the aperture 38 is off-center, these distances (L7-L12) are dissimilar.

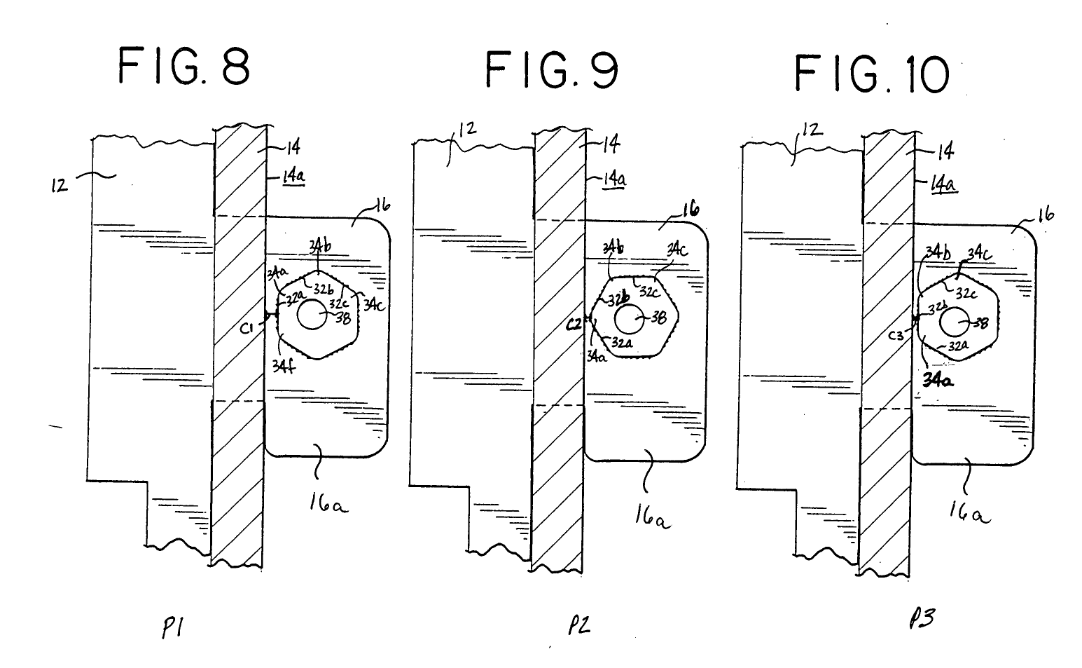

As mentioned above, the fastener assembly 10 is configured to rigidly secure the first structure 12 to the second structure 14. This is accomplished primarily by the locking washer 30 which engages the inner surface 14a of the second support 14. Referring to FIGS. 1 and 7, the first structure 12 is positioned adjacent to the second structure 14 whereby the tab 16 is inserted through the slot 18. Once the first structure 12 is properly positioned with respect to the second structure 14 and to begin the process of securing the structures 12, 14, the bolt 50 is inserted through the opening 17 in the tab 16. As shown in FIG. 8, the locking washer 30 is then placed in a first position P1 wherein the bolt 50 is received by the locking washer 30. Preferably, the locking washer 30 and the bolt 50 are cooperatively dimensioned, meaning the inner diameter of the aperture 38 of locking washer 30 corresponds to the threads on the bolt 50, to prevent “slop” or unwanted movement transverse to the longitudinal axis of the bolt 50 during rotation of the locking washer 30.

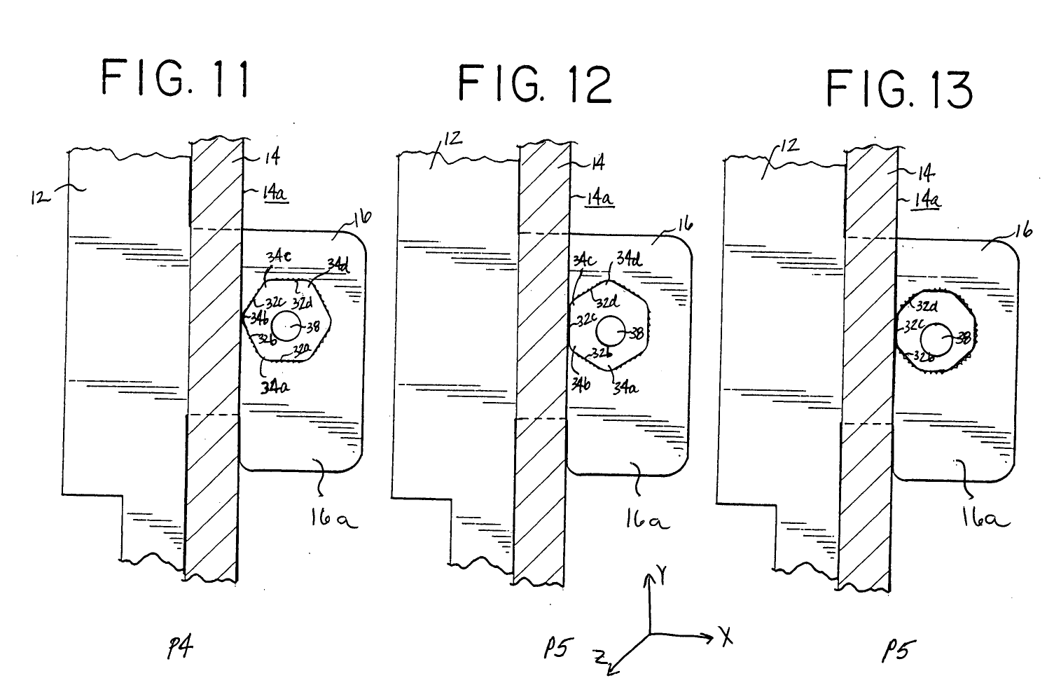

In the first position P1, a first clearance C1 is defined as the distance between the first side wall 32a and the inner surface 14a of the second structure 14. In the first position P1, there is no engagement between the locking washer 30 and the second structure 14. Because the locking washer 30 has an eccentric aperture 38 and the lengths to the side walls 32 are distinct, the locking washer 30 can be selectively rotated to eliminate the clearance and bring a side wall 32 into engagement with the inner surface 14a. As shown in FIG. 9, the locking washer 30 has been rotated in a counter-clockwise direction to a second position P2. To reach the second position, the locking washer 30 is rotated approximately 30 degrees; however, the precise amount of rotation varies with the design parameters of the locking washer 30. Unlike conventional washers, the locking washer 30 is rotated by applying a rotational force to its periphery. Described in a different manner, a standard wrench is used to engage the side walls 32 and rotate the locking washer 30. In the second position P2, a second clearance C2 is defined as the distance between the first corner 34a and the inner surface 14a. There, the first corner 34a is positioned closest to the inner surface 14a and the first and second side walls 32a,b are angularly positioned with respect to the inner surface 14a. As shown in FIG. 10, the locking washer 30 has been rotated in a counter-clockwise direction to a third position P3. In the third position P3, a third clearance C3 is defined as the distance between the second side wall 32b and the inner surface 14a. Due to the configuration of the locking washer 30, the first clearance C1 is greater than the second clearance C2, and the second clearance C2 is greater than the third clearance C3. Since there is no engagement between the locking washer 30 and the inner surface 14a, the locking washer 30 must be further rotated. As shown in FIG. 11, the locking washer 30 has been rotated in a counter-clockwise direction to a fourth position P4. In the fourth position P4, the second rounded corner 34b engages the inner surface 14a and precludes any clearance between the locking washer 30 and the inner surface 14a. There, the second and third side walls 32b,c are angularly positioned with respect to the inner surface 14a. At least the corners 34 of the locking washer 30 are deformable and as a result, the locking washer 30 can be rotated past the fourth position P4. Once the second corner 34b is brought into contact with the inner surface 14a, additional rotational force is applied to the locking washer 30 thereby causing deformation of the second corner 34b and permitting the locking washer 30 to further rotate. As shown in FIG. 12, the locking washer 30 has been rotated in a counter-clockwise position to a fifth position P5. Because the corners 34 are rounded and deformable, the locking washer 30 can be rotated from the fourth position P4 to the fifth position P5. In the fifth position P5, the third side wall 32c engages the inner surface 14 thereby precluding any clearance between the locking washer 30 and the inner surface 14a. Specifically, the teeth 36 of the third side wall 32c fixedly grip the inner surface 14a. Once the locking washer 30 is in the fifth position P5, the nut 20 can be applied to the bolt 50 and tightened against the locking washer 30.

In the fifth position P5 or locking position, the locking washer 30 exerts a force generally transverse to the inner surface 14a which can be characterized as a clamping force. In addition, the engagement of the teeth 36 with the inner surface 14a imparts a gripping force. Unlike conventional washers, the locking washer 30 exerts a locking force on the inner surface 14a in the fifth position P5. In the fifth position P5, the locking washer 30 provides locking support for the first and second structures 12, 14. This means that the engagement between the locking washer 30 and the inner surface 14a secures the first structure 12 to the second structure 14 and prevents movement along both the X-axis and the Y-axis (see FIG. 1). In this manner, the locking washer 30 prevents unwanted movement of the first structure 12 with respect to the second structure 14. When the nut 20 is sufficiently tightened, the nut 20 prevents movement of the fastener assembly 10 along the Z-axis (see FIG. 1). In the fifth position P5, no additional structure, such as bracing or reinforcing supports, is required to secure the first structure 12 to the second structure 14. This means that no bracing structures for the tab 16 and/or the second support 14 are necessary. However, the tab 16 must be configured to extend a sufficient distance beyond the inner surface 14 such that an opening 17 can be formed in the tab 16.

One of skill in the art recognizes that the locking engagement depicted in the fifth position P5 depends in part on the design parameters of the first and second structures 12,14. One of skill further recognizes that the design parameters of the first and second structures 12, 14 could be altered such that the locking engagement provided by the locking washer 30 occurs with either less or more rotations than that shown in FIGS. 8-12. For example, the position of the opening 17 in the tab 16 of the second structure 12 can be altered to require a single rotation of the corners 34 of the locking washer 30 (shown as FIGS. 10-12) to result in the locking position P5.

As shown in FIGS. 1 and 8-12, the first structure 12 is a blade-like element that is supported generally perpendicular to an outer surface 14b of the support structure 14, which is depicted as a generally panel-like structure. Alternatively, the first structure 12 can be configured as a panel with an inner surface that mates with the outer surface 14b when the fastening assembly 10 is in the locking position. For example, the first structure 12 can be an exterior stone panel that is fixedly secured to a vertical wall of a building.

The locking washer 30 can be configured for greater or lesser engaging force between the first and second structures 12, 14. For example, the diameter of the aperture 38 can be enlarged or reduced relative to the side walls 32 of the locking washer 30. Also, the exact location of the aperture 38 within the locking washer 30 can be altered thereby affecting the degree of asymmetry. In addition, the angle or orientation of the aperture 38 relative to a surface plane of the locking washer 30 plane can be revised. Angling of the aperture 38 will permit the locking washer 30 to move transverse to the axis of rotation. Furthermore, the dimensions, including the perimeter P and thickness T, of the locking washer 30 can be varied. Lastly, the characteristics, including the pitch, height, angle, and patterns, of the teeth 36 can be adjusted.

Although shown in FIGS. 1-12 as a hexagon with six side walls 32, the locking washer 30 can have a variety of configurations. For example and as shown in FIG. 13, the locking washer 130 is an octagon with eight side walls. There the third side wall 132c engages the inner surface 14a to support the first and second structures 12, 14. As another example, the locking washer can have between three to ten side walls. As shown in the Figures and previously described, the side walls 32 are substantially perpendicular to the end walls 31, 33; however, the side walls 32 can be angled or sloped. In this configuration, the side wall 32 can be angled towards the first end wall 31 or away from the first end wall 31. The precise configuration of the locking washer 30, including the number of side walls, can be varied with the design parameters of the locking washer 30 and the engineering dynamics of the first and second structures 12, 14.

The locking washer 30 can be formed from a variety of materials. For example, the locking washer 30 can be fabricated from plastic or metal, such as aluminum or steel. In addition, the locking washer 30 can be fabricated from a composite of metals, plastics or ceramics. Since the locking washer 30 has rounded corners 34 that are deformable, the locking washer 30 can be easily rotated to ensure engagement between the side wall 32 and the inner surface 14a of the support structure 14. To increase its utility, a standard wrench can be used to rotate and tighten the locking washer 30 by engaging the side walls 32.

As explained above, the locking washer 30 is utilized to secure structures wherein at least one structure is in tension. The locking washer 30 can be utilized in a variety of other applications. For example, the locking washer 30 can secure structures wherein at least one structure is in compression and where the structure may have an irregular configuration. Furthermore, the locking washer 30 can be utilized to secure structures wherein the structures are in tension, compression, and/or shear. Also, the locking washer 30 can be utilized to secure structures where at least one structure experiences a bending or twisting force.

While the specific embodiment has been illustrated and described, numerous modifications come to mind without significantly departing from the spirit of the invention, and the scope of protection is only limited by the scope of the accompanying claims.

1. A fastener assembly for securing structures, the fastener assembly comprising:
a bolt;
a nut; and,
a locking washer having a plurality of side walls, the locking washer further having an eccentric aperture wherein the distance from a periphery of the aperture to each side wall is distinct.

2. The fastener assembly of claim 1 wherein the locking washer has a plurality of teeth positioned on each side wall.

3. The fastener assembly of claim 1 wherein the locking washer has a plurality of corners defined by abutting side walls, and wherein the corners are deformable when a sufficient rotational force is applied to the locking washer.

4. The fastener assembly of claim 3 wherein the aperture has a center and wherein the distance between the center of the aperture and each corner is distinct.

5. The fastener assembly of claim 1 wherein the locking washer has a centrum and the aperture is misaligned with the centrum.

6. The fastener assembly of claim 1 wherein the aperture has a center and wherein the distance between the center of the aperture and each side wall is distinct.

7. The fastener assembly of claim 1 wherein the aperture of the locking washer is threaded.

8. A locking washer for use as a component in a fastener assembly for securing structures, the locking washer comprising:
a body having a plurality of side walls, the body further having an eccentric aperture wherein the distance from a center of the aperture to each side wall is distinct.

9. The locking washer of claim 8 wherein each side wall has at least one tooth configured to lockingly engage one of the structures to be secured.

10. The locking washer of claim 8 wherein the distance between a periphery of the aperture and each side wall is distinct.

11. A fastener assembly for securing a first structure to a second structure, the fastener assembly comprising:
a bolt;
a nut; and,
a locking washer having a plurality of side walls and an eccentric aperture, the locking washer rotatable between an initial position wherein a first side wall does not engage the second structure, an intermediate position wherein a first corner slidably engages the second structure, and a locked position wherein a second side wall lockingly engages the second structure.

12. The fastener assembly of claim 11 wherein in the initial position, a first clearance is defined between the first side wall and the second structure.

13. The fastener assembly of claim 12 wherein the first corner deforms as the locking washer rotates between the second and third positions.

14. The fastener assembly of claim 11 wherein the second side wall has a plurality of teeth configured to engage the second structure in the locked position.

15. The fastener assembly of claim 11 wherein each side wall has a has a plurality of teeth configured to engage the second structure in the locked position.

16. The fastener assembly of claim 11 wherein the first side wall is positioned at an angle to the second structure in the locked position.

17. The fastener assembly of claim 11 wherein in the locked position, the engagement between the locking washer and the second structure prevents movement of the first structure with respect to the second structure.

18. The fastener assembly of claim 17 wherein the engagement between the locking washer and the second structure prevents movement of the first structure in a direction transverse to a longitudinal axis of the bolt.

19. The fastener assembly of claim 11 wherein the locking washer is configured such that the distance between a periphery of the aperture and each side wall is distinct.

20. The fastener assembly of claim 11 wherein the locking washer is configured such that the distance between a center of the aperture and each side wall is distinct.
